(19) United States
(12) Patent Application Publication
(10) Pub. No.: US 2026/0261389 A1
(43) Pub. Date: Sep. 3, 2026

(54) METHOD FOR SENDING INDICATION INFORMATION OF SD-FD BASIS PAIR, METHOD FOR RECEIVING INDICATION INFORMATION OF SD-FD BASIS PAIR, AND SYSTEM

(71) Applicant: Beijing Xiaomi Mobile Software Co., Ltd., Beijing (CN)

(72) Inventor: Mingju LI, Beijing (CN)

(21) Appl. No.: 18/995,739

(22) PCT Filed: Jul. 22, 2022
(86) PCT No.: PCT/CN2022/107541

§ 371 Date: Jan. 16, 2025

(51) Int. Cl. H04L 5/00; H04B 7/0417; H04B 7/06; H04W 72/044

(52) U.S. Cl. CPC H04L 5/0094; H04B 7/0417; H04B 7/0626; H04W 72/044

(57) ABSTRACT

A method for sending indication information of a spatial domain-frequency domain (SD-FD) basis pair, including: sending indication information to a base station, where the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

### CROSS-REFERENCE TO RELATED APPLICATIONS

The present application is a U.S. National Stage of International Application No. PCT/CN2022/107541, entitled “METHOD AND APPARATUS FOR SENDING INDICATION INFORMATION REGARDING SD-FD BASIS PAIR, METHOD AND APPARATUS FOR RECEIVING INDICATION INFORMATION REGARDING SD-FD BASIS PAIR, AND SYSTEM”, filed on Jul. 22, 2022, the contents of all of which are incorporated herein by reference in their entireties for all purposes.

### BACKGROUND

Transmission efficiency and reliability can be improved by precoding or beamforming of multiple sending antennas in a multiple-input multiple-output (MIMO) wireless communication system.

### SUMMARY

The present disclosure relates to, but not limited to, the technical field of wireless communication, and in particular to a method for sending indication information of a spatial domain-frequency domain (SD-FD) basis pair, a method for receiving indication information of an SD-FD basis pair, a system, a communication device and a storage medium.

According to a first aspect of an example of the present disclosure, a method for sending indication information of a spatial domain-frequency domain (SD-FD) basis pair is provided. The method is performed by a terminal, and includes:
sending indication information to a base station, where
the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

According to a second aspect of an example of the present disclosure, a method for receiving indication information of a spatial domain-frequency domain (SD-FD) basis pair is provided. The method is performed by a base station, and includes:
receiving indication information sent by a terminal, where
the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

According to a third aspect of an example of the present disclosure, a system for transmitting indication information of a spatial domain-frequency domain (SD-FD) basis pair is provided. The system includes a terminal and a base station, where the terminal performs the method provided by the first aspect of the present disclosure, and the base station performs the method provided by the second aspect of the present disclosure.

According to a fourth aspect of an example of the present disclosure, a communication device is provided. The communication device includes:
a memory that stores computer-executable instructions; and
one or more processors that are communicatively coupled to the memory, where the computer-executable instructions when collectively executed by the one or more processors cause the communication device to:
send indication information to a base station, where the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

According to a fifth aspect of an example of the present disclosure, a communication device is provided. The communication device includes:
a memory that stores computer-executable instructions; and
one or more processors that are communicatively coupled to the memory, where the computer-executable instructions, when collectively executed by the one or more processors, implement the method provided by the second aspect of the present disclosure.

According to a sixth aspect of an example of the present disclosure, a non-transitory computer storage medium is provided. The non-transitory computer storage medium stores computer-executable instructions, and the computer-executable instructions, when executed by a processor, implement the method provided by the first aspect of the present disclosure.

### BRIEF DESCRIPTION OF DRAWINGS

FIG. 1 is a schematic structural diagram of a wireless communication system;

FIG. 2 is a schematic flow diagram of a method for sending indication information of a spatial domain-frequency domain (SD-FD) basis pair shown according to an example;

FIG. 3 is a schematic flow diagram of a method for sending indication information of a spatial domain-frequency domain (SD-FD) basis pair shown according to an example;

FIG. 4 is a schematic flow diagram of a method for sending indication information of a spatial domain-frequency domain (SD-FD) basis pair shown according to an example;

FIG. 5 is a schematic flow diagram of a method for receiving indication information of a spatial domain-frequency domain (SD-FD) basis pair shown according to an example;

FIG. 6 is a schematic flow diagram of a method for receiving indication information of a spatial domain-frequency domain (SD-FD) basis pair shown according to an example;

FIG. 7 is a schematic flow diagram of a method for receiving indication information of a spatial domain-frequency domain (SD-FD) basis pair shown according to an example;

FIG. 8 is a schematic diagram of a device for sending indication information of a spatial domain-frequency domain (SD-FD) basis pair shown according to an example;

FIG. 9 is a schematic diagram of a device for receiving indication information of a spatial domain-frequency domain (SD-FD) basis pair shown according to an example;

FIG. 10 is a schematic diagram of a system for transmitting indication information of a spatial domain-frequency domain (SD-FD) basis pair shown according to an example;

FIG. 11 is a block diagram of a user equipment shown according to an example; and

FIG. 12 is a block diagram of a second base station shown according to an example.

### DETAILED DESCRIPTION

In order to achieve high-performance precoding or beamforming, a precoding matrix or a beamforming vector is required to be well-matched to a channel, which requires a transmitting end to accurately obtain channel state information (CSI). Consequently, CSI feedback is a key technology for enabling high-performance precoding or beamforming in the MIMO system. CSI is used to indicate a spatial domain basis (SD basis) and a frequency domain basis (FD basis). However, signaling overhead is high and transmission performance is low in the related art.

A method for sending indication information of a spatial domain-frequency domain (SD-FD) basis pair, a method for receiving indication information of an SD-FD basis pair, a system, a communication device and a storage medium are disclosed in examples of the present disclosure.

The examples will be described in detail here and are illustratively shown in the accompanying drawings. When the following descriptions relate to the accompanying drawings, unless otherwise specified, the same numerals in different accompanying drawings denote the same or similar elements. The examples described in the following examples do not denote all examples consistent with the examples of the present disclosure. On the contrary, the examples are examples of a device and a method consistent with some aspects of the examples of the present disclosure as detailed in the appended claims.

The terms used in the examples of the present disclosure are to describe the specific examples, instead of limiting the examples of the present disclosure. The singular forms such as “a”, “an”, “the” and “this” used in the examples of the present disclosure and the appended claims are also intended to include the plural forms, unless otherwise clearly stated in the context. It may be further understood that the term “and/or” used here refers to and includes any of one or more of the associated listed items or all possible combinations.

It may be understood that although the terms of first, second, third, etc. can be used in the examples of the present disclosure to describe any type of information, such information should not be limited to these terms. These terms are used to distinguish the same type of information from each other. For example, without departing from the scope of the examples of the present disclosure, first information may also be referred to as second information, and similarly, the second information may also be referred to as the first information. Depending on the context, the word “if” as used here can be interpreted as “at the time of” or “when” or “in response to determining”.

For the sake of brevity and ease of understanding, the terms “greater than” or “less than” are used here to characterize size relations. However, for those skilled in the art, it can be understood that the term “greater than” also covers the meaning of “greater than or equal to”, and “less than” also covers the meaning of “less than or equal to”.

With reference to FIG. 1, a schematic structural diagram of a wireless communication system according to an example of the present disclosure is shown. As shown in FIG. 1, the wireless communication system is a communication system based on a cellular mobile communication technology, and may include a plurality of first user equipment (UE) 110 and a plurality of first base stations 120.

The first UE 110 may be a device that provides voice and/or data connectivity for a user. The first UE 110 may communicate with one or more core networks via a radio access network (RAN). The first UE 110 may be a Internet of Things user equipment, such as a sensor device, a mobile phone (also known as a “cellular” phone) and a computer having the Internet of Things user equipment. For example, the first UE 110 may be a fixed, portable, pocket, hand-held, computer built-in, or vehicle-mounted device. For example, the first UE 110 may be a station (STA), a subscriber unit, a subscriber station, a mobile station, a mobile, a remote station, an access point, a remote terminal, an access terminal, a user terminal, a user agent, a user device, or a user equipment. Alternatively, the first UE 110 may be an Industry Internet of Things (IIoT) device, such as a forklift and an automatic assembly device. Alternatively, the first UE 110 may be a device of an unmanned aerial vehicle. Alternatively, the first UE 110 may be a vehicle-mounted device, for example, an driving computer having a wireless communication function, or a wireless user equipment externally connected to the driving computer. Alternatively, the first UE 110 may be a roadside device, for example, a street lamp, a signal lamp or another roadside device having the wireless communication function.

The first base station 120 may be a network-side device in the wireless communication system. The wireless communication system may be the 4th generation mobile communication (4G) system, and is also known as a long term evolution (LTE) system. Or, the wireless communication system may be a 5G system, and is also known as a new radio (NR) system or a 5G NR system. Alternatively, the wireless communication system may be a next-generation system after the 5G system. An access network in the 5G system may be known as a new generation-radio access network (NG-RAN). It may be noted that in the present disclosure, the first base stations 120 may be at least one transmitter receiver point (TRP).

The first base station 120 may be an evolved base station (eNB) used in the 4G system. Alternatively, the first base station 120 may be a base station (gNB) using centralized distributed architectures in the 5G system. When the first base stations 120 use the centralized distributed architectures, the first base stations 120 each usually includes a central unit (CU) and at least two distributed units (DUs). Protocol stacks of a packet data convergence protocol (PDCP) layer, a radio link control (RLC) layer, and a media access control (MAC) layer are arranged in the CU; and protocol stacks of physical (PHY) layers are arranged in the DU. The specific implementation of the first base stations 120 is not limited in the example of the present disclosure.

Wireless connections may be established between the first base stations 120 and the first UE 110 through radio air interfaces. In different examples, the radio air interface is a radio air interface based on the 4th generation mobile communication (4G) standard; alternatively, the radio air interface is a radio air interface based on the fifth generation mobile communication (5G) standard, for example, a NR; and alternatively, the radio air interface may be a radio air interface based on a next-generation mobile communication network technology standard after 5G.

In some examples, an end to end (E2E) connection may be further established between first UE 110, for example, vehicle to vehicle (V2V) communication, vehicle to infrastructure (V2I) communication and vehicle to pedestrian (V2P) communication in vehicle to everything (V2X) communication.

The above first UE 110 may be considered as a terminal 101 in the following example.

In some examples, the above wireless communication system may further include a network management device 130.

The a plurality of first base stations 120 are each connected to the network management device 130. The network management device 130 may be a core network device in the wireless communication system. For example, the network management device 130 may be a mobility management entity (MME) in an evolved packet core (EPC). Alternatively, the network management device may be another core network device, such as a serving gateway (SGW), a public data network gateway (PGW), a policy and charging rules function (PCRF), or a home subscriber server (HSS). Alternatively, the network management device 130 may be an entity having a location management function. The implementation form of the network management device 130 is not limited in the example of the present disclosure.

In order to conveniently understand any example of the present disclosure, an application scenario of the CSI feedback in the related art is described firstly.

The CSI feedback includes a precoding matrix indicator (PMI). The PMI includes a PMI includes a spatial domain basis (SD basis) indicator and a frequency domain (FD) basis indicator. Indication is separately performed by the SD basis indicator and the FD basis indicator.

For example, the SD basis indicator indicates that L bases are selected from N₁×N₂ bases, and thus a number of bits indicated by the SD basis indicator is:

$$⌈ {log}_{2} ( \begin{matrix}{N}_{1} {N}_{2} \\ L\end{matrix} ) ⌉ .$$

For the FD basis indicator, for example, M FD units are directly selected from N₃ FD units as bases when the total number N₃ of the FD units is less than or equal to 19. A first FD unit needs to be selected here, and a number of bits indicated is:

$$⌈ {log}_{2} ( \begin{matrix}{N}_{3} - 1 \\ M - 1\end{matrix} ) ⌉ .$$

If N₃ is greater than 19, the terminal 101 may be limited to select M FD units from 2M FD units in order to reduce signaling overheads. Firstly, a starting point of a 2M window needs to be indicated, a number of bits indicated is:

$$⌈ {log}_{2} 2 M ⌉ ,$$

and
an FD unit corresponding to the starting point of the window is also a selected FD unit, and a number of bits indicated needed for another M−1 FD units is:

$$⌈ {log}_{2} ( \begin{matrix}2 M - 1 \\ M - 1\end{matrix} ) ⌉ .$$

In actual transmission, it is needed to perform transmission through a combination of an SD basis and an FD basis. The SD basis and the FD basis are independently selected and reported by the terminal 101, and some combinations of SD bases and FD bases are poor in performance. Thus, in order to indicate performance of each combination of the SD basis and the FD basis, the terminal 101 needs to indicate performance parameters of each combination, for example, an amplitude factor and a phase factor of each combination. In order to indicate the amplitude factor and the phase factor, the terminal 101 firstly needs 2LM (corresponding to 2 polarization directions) bit maps to indicate which combinations correspond to non-zero amplitudes and which combinations correspond to zero amplitudes, and then further indicates the amplitude factor and the phase factor of each combination in combinations corresponding to the non-zero amplitudes.

In an example, L SD bases are selected from N₁×N₂ bases, and

$${M}_{υ} ( {M}_{υ} = ⌈ {p}_{υ} \frac{{N}_{3}}{R} ⌉ )$$

FD bases are selected from N₃ units. Some of 2LM SD-FD basis pairs are poor in performance. That is, coefficients of some of 2LM SD-FD basis pairs are zero. The 2LM bit maps are needed to indicate β2LM non-zero coefficients at each layer. β is a decimal fraction. That is, the non-zero coefficients are less than 2LM.

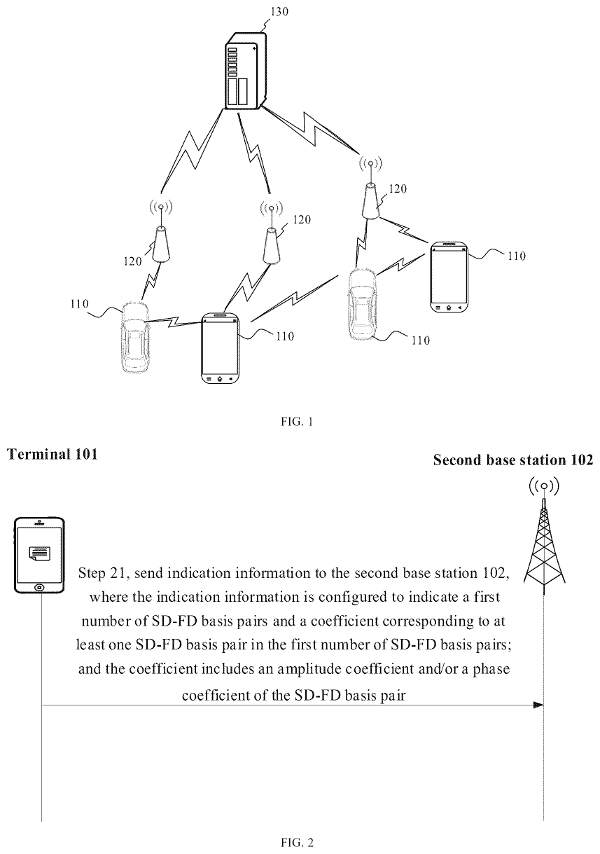

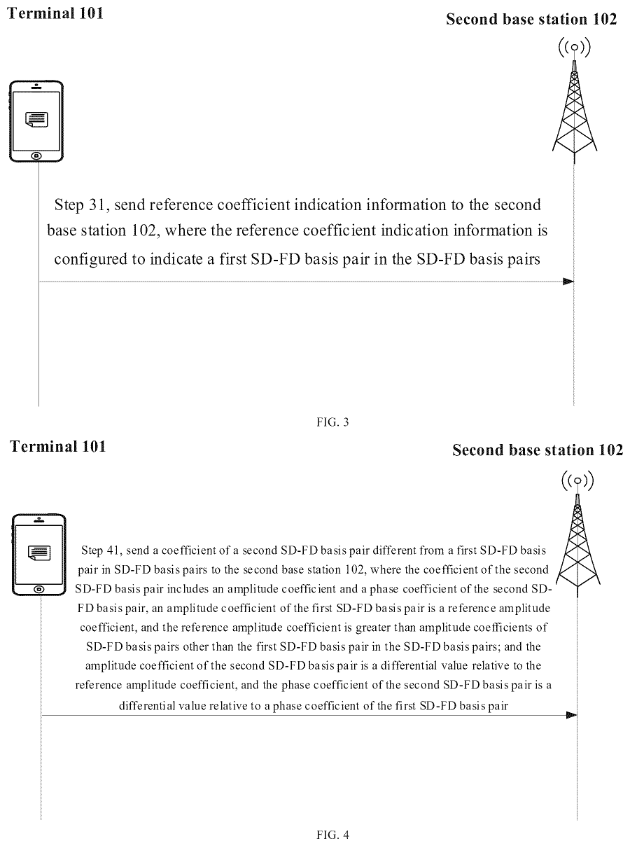

As shown in FIG. 2, a method for sending indication information of a spatial domain-frequency domain (SD-FD) basis pair is provided in the example. The method is performed by the terminal 101, and includes:
step 21, indication information is sent to a second base station 102.

The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

The terminal 101 involved in the present disclosure may be, but not limited to, a mobile phone, a wearable device, a vehicle-mounted terminal, a road side unit (RSU), a smart home terminal, an industrial sensing device, and/or a medical device. In some examples, the terminal 101 may be a Redcap terminal or a predetermined version of new radio (NR) terminal (for example, an NR terminal of R17).

The second base station 102 is an interface device for the terminal 101 to access a network. The second base station 102 may be any type of base station, for example, a base station of a third generation mobile communication (3G) network, a base station of a fourth generation mobile communication (4G) network, a base station of a fifth generation mobile communication (5G) network, or other evolved base stations.

In an example, the indication information is sent to the second base station 102 in response to establishment of a radio resource control (RRC) connection. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, in response to receiving a request information to acquire the indication information, the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, information for determining the first number sent by the second base station 102 is received; the first number is determined based on the information; and the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, the indication information is sent to the second base station 102. The indication information is configured to indicate a first number of SD-FD basis pairs and a coefficient corresponding to at least one SD-FD basis pair in the first number of SD-FD basis pairs, the coefficient includes at least one of an amplitude coefficient or a phase coefficient of the at least one SD-FD basis pair, and the first number is determined according to codebook parameter configuration information sent by the second base station 102 and/or number information of the SD-FD basis pairs sent by the second base station 102.

In an example, the codebook parameter configuration information sent by the second base station 102 is received; the first number is determined based on the codebook parameter configuration information; and the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

Illustratively, for the codebook parameter configuration information, reference is made to L, p_{ν} and β in table 1, where M_{ν} (for example,

$${M}_{υ} = ⌈ {p}_{υ} \frac{{N}_{3}}{R} ⌉ ) .$$

N₃ and R may be obtained based on other configuration information. M_{ν} may be obtained based on p_{ν} in the codebook parameter configuration information. M_{ν} is M of a v-th layer. The first number determined based on the table 1 is β2LM (the number of basis pairs indicated at each layer). Illustratively, for the table 1, reference may be made to Rel-16 Type II-table 1. It may be noted that a value of each parameter may be different from that in the table 1, which is not limited in the present disclosure.

TABLE 1

| Parameter | |
|---|---|
| combination- | |
| version | p_{υ} |

| R16 | L | υ∈{1, 2} | υ∈{3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

Illustratively, for the codebook parameter configuration information, reference is made to M, α and β in table 2. N₁ and N₂ may be obtained through other configuration information. The first number determined based on the table 2 is 2αBN₁N₂M (the number of basis pairs indicated at each layer). Illustratively, for the table 2, reference may be made to a parameter table of Rel-17 Type II port selection codebook-table 2. It may be noted that a value of each parameter may be different from that in the table 2, which is not limited in the present disclosure.

TABLE 2

| Parameter | | | |
|---|---|---|---|
| combination- | | | |
| version | | | |
| R17 | M | α | β |
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

It may be noted that determination of the first number is not limited to a parameter form of the above tables, and the second base station 102 provides a form of the value of each parameter just for the terminal 101 to determine the first number.

In an example, the number information of SD-FD basis pairs sent by the second base station 102 is received; the first number is determined based on the number information of the SD-FD basis pairs; and indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, the codebook parameter configuration information and the number information of SD-FD basis pairs sent by the second base station 102 are received; and the first number is determined according to the codebook parameter configuration information and the number information of the SD-FD basis pairs. The indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair. In an example, the first number is determined according to a predetermined rule; and the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair. The predetermined rule may be determined based on locally stored rule information. In an example, the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair. The amplitude coefficient is a non-zero coefficient.

It may be noted that if an amplitude coefficient of a selected SD-FD basis pair is zero, the terminal 101 indicates that the selected SD-FD basis pairs do not include the SD-FD basis pair.

In an example, an SD-FD basis pair is selected, the amplitude coefficient of the SD-FD basis pair is non-zero; and the indication information is sent to the second base station 102. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, the indication information is sent to the second base station 102. The indication information is configured to indicate a first number of SD-FD basis pairs and a coefficient corresponding to at least one SD-FD basis pair in the first number of SD-FD basis pairs, the coefficient includes at least one of an amplitude coefficient or a phase coefficient of the at least one SD-FD basis pair; and a number of bits of an information domain of the indication information is determined based on the first number. Illustratively, if the first number is greater than a number threshold, the number of the bits of the information domain may be greater than a reference threshold; and alternatively, if the first number is less than the number threshold, the number of the bits of the information domain may be less than the reference threshold.

Illustratively, the number of enhanced bits based on the Rel-16 type II is:

$$⌈ {log}_{2} ( \begin{matrix}{N}_{1} {N}_{2} {N}_{3} \\ pair number\end{matrix} ) ⌉ .$$

N₁ and N₂ correspond to the number of first-dimension bases and the number of second-dimension bases respectively, and N₃ is the number of FD bases. When N₃ is greater than 19, N₃ may be replaced with a small value of a length of an FD window. A value of a length of the FD window is 2M in the similar related art. M is the number of FD bases to be selected. The pair number is the first number.

Illustratively, the number of enhanced bits based on the Rel-17 type II port selection codebook is:

$$⌈ {log}_{2} ( \begin{matrix}{N}_{1} {N}_{2} N \\ pair number\end{matrix} ) ⌉ .$$

N₁ and N₂ correspond to the number of first-dimension bases and the number of second-dimension bases respectively, and Nis a length of the FD window. The pair number is the first number.

In an example, the SD-FD basis pairs include a first SD-FD basis pair and a second SD-FD basis pair.

In an example, a reference coefficient indication information is sent to the second base station 102. The reference coefficient indication information is configured to indicate the first SD-FD basis pair in the SD-FD basis pairs; and an amplitude coefficient of the first SD-FD basis pair is a reference amplitude coefficient, and the reference amplitude coefficient is not less than an amplitude coefficient of a SD-FD basis pair other than the first SD-FD basis pair in the SD-FD basis pairs. For example, the reference amplitude coefficient may be a maximum coefficient in the amplitude coefficients of the SD-FD basis pairs.

In an example, an SD-FD basis pair corresponding to a reference amplitude coefficient is indicated firstly, and a number of bits needed is:

┌log₂ pair number┐.

The pair number is the first number.

It may be noted that an amplitude of the SD-FD basis pair may be normalized to 1, and if a phase of the SD-FD basis pair is 0, report is not needed. For amplitudes and phases of other SD-FD basis pairs, a differential value relative to the SD-FD basis pair corresponding to relative reference amplitude coefficient may be reported.

In an example, the reference coefficient indication information is sent to the second base station 102 for different polarization directions. The reference coefficient indication information is configured to indicate the first SD-FD basis pair; and the amplitude coefficient of the first SD-FD basis pair is the reference amplitude coefficient.

In an example, the reference coefficient indication information is sent to the second base station 102 by taking one or more channel measurement resources as units. The reference coefficient indication information is configured to indicate the first SD-FD basis pair; and the amplitude coefficient of the first SD-FD basis pair is the reference amplitude coefficient.

In an example, the reference coefficient indication information is sent to the second base station 102 by taking one or more port groups of channel measurement resources as units. The reference coefficient indication information is configured to indicate the first SD-FD basis pair; and the amplitude coefficient of the first SD-FD basis pair is the reference amplitude coefficient.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. The reference coefficient indication information includes channel measurement resource identification information; and alternatively, the reference coefficient indication information includes port group identification information of channel measurement resources.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. The reference coefficient indication information includes channel measurement resource identification information in response to taking one or more channel measurement resources as units; and alternatively, the reference coefficient indication information includes port group identification information of channel measurement resources in response to taking one or more port groups of channel measurement resources as units. In an example, the reference coefficient indication information is sent to the second base station 102. The reference coefficient indication information is configured to indicate the first SD-FD basis pair; and the amplitude coefficient of the first SD-FD basis pair is the reference amplitude coefficient. If the reference coefficient indication information is sent by taking a plurality of channel measurement resources as units, the reference coefficient indication information includes a plurality of channel measurement resource identification information or channel measurement resource combination identification information. A plurality of channel measurement resource identifications corresponding to each channel measurement resource combination identification are configured by the second base station 102, indicated by the terminal 101 or determined based on a default rule. Alternatively, if the reference coefficient indication information is sent by taking a plurality of port groups of channel resources as units, the reference coefficient indication information includes port group identification information of a plurality of channel measurement resources or combination identification information of port groups of channel measurement resource combinations. A plurality of port group identifications of the channel measurement resources corresponding to combination identifications of port groups of each channel measurement resource are configured by the second base station 102, indicated by the terminal 101, or determined based on a default rule.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. A coefficient of the second SD-FD basis pair different from the first SD-FD basis pair in the SD-FD basis pairs is sent to the second base station 102. The coefficient of the second SD-FD basis pair includes an amplitude coefficient and a phase coefficient of the second SD-FD basis pair. The amplitude coefficient of the second SD-FD basis pair is a differential value relative to the reference amplitude coefficient; and the phase coefficient of the second SD-FD basis pair is a differential value relative to a phase coefficient of the first SD-FD basis pair.

In an example, for different transmitter receiver points (TRPs), a reference amplitude coefficient may be indicated for all the TRPs. That is, an SD-FD basis pair corresponding to the reference amplitude coefficient and a channel measurement resource identification (ID) or a port group ID of channel measurement resources corresponding to the reference amplitude coefficient need to be indicated, and non-reference SD-FD basis pairs of the TRPs and all SD-FD basis pairs of other TRPs are relative values for reference SD-FD basis pairs corresponding to the reference amplitude coefficient. Alternatively, each TRP indicates a respective reference amplitude coefficient, and SD-FD basis pairs corresponding to other non-reference amplitude coefficients in each TRP are differential values relative to reference SD-FD basis pairs corresponding to respective reference amplitude coefficients. That is, different TRPs correspond to different channel measurement resource identifications (IDs) or different port group IDs of the channel measurement resources. Indication of the channel measurement resource identifications (IDs) or the port group IDs of the channel measurement resources is equivalent to indication of the TRPs.

In an example, the channel measurement resources may be channel state information reference signal (CSI-RS) resources, port groups of the channel measurement resources may be one of a plurality of port groups into which ports corresponding to the CSI-RS are divided, and ports included in each port group are configured by the second base station 102 or determined based on a default rule.

In the example of the present disclosure, the indication information is sent to the second base station 102. The indication information is configured to indicate the first number of SD-FD basis pairs and the coefficient corresponding to the at least one SD-FD basis pair in the first number of the SD-FD basis pairs, and the coefficient includes at least one of the amplitude coefficient or the phase coefficient of the at least one SD-FD basis pair. An SD basis and an FD basis can be jointly indicated based on the indication information here. Signaling overheads can be reduced compared with a manner of separate indication. Moreover, the indication information can further indicate at least one of the amplitude coefficient or the phase coefficient corresponding to the at least one SD-FD basis pair in the first number of SD-FD basis pairs, such that the indication information can be configured to determine performance of each SD-FD basis pair. SD-FD basis pair(s) having excellent performance can be selected for data transmission, improving transmission performance.

It may be noted that those skilled in the art can understand that the method according to the example of the present disclosure can be performed separately or together with some methods in the examples of the present disclosure or the related art.

As shown in FIG. 3, a method for sending indication information of a spatial domain-frequency domain (SD-FD) basis pair is provided in the example. The method is performed by the terminal 101, and includes:
step 31, the reference coefficient indication information is sent to the second base station 102.

The reference coefficient indication information is configured to indicate the first SD-FD basis pair in the SD-FD basis pairs.

In an example, the SD-FD basis pairs include the first SD-FD basis pair and the second SD-FD basis pair.

In an example, the reference coefficient indication information is sent to the second base station 102. The reference coefficient indication information is configured to indicate the first SD-FD basis pair in the SD-FD basis pairs, and the amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs.

In an example, the reference coefficient indication information is sent to the second base station 102 for different polarization directions. The reference coefficient indication information is configured to indicate the first SD-FD basis pair in the SD-FD basis pairs; and the amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs.

In an example, the reference coefficient indication information is sent to the second base station 102 by taking one or more channel measurement resources as units. The reference coefficient indication information is configured to indicate the first SD-FD basis pair; and the amplitude coefficient of the first SD-FD basis pair is the reference amplitude coefficient.

In an example, the reference coefficient indication information is sent to the second base station 102 by taking one or more port groups of channel measurement resources as units. The reference coefficient indication information is configured to indicate the first SD-FD basis pair; and the amplitude coefficient of the first SD-FD basis pair is the reference amplitude coefficient.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. The reference coefficient indication information includes channel measurement resource identification information; and alternatively, the reference coefficient indication information includes port group identification information of channel measurement resources.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. The reference coefficient indication information includes channel measurement resource identification information by taking one or more channel measurement resources as units; and alternatively, the reference coefficient indication information includes port group identification information of channel measurement resources by taking one or more port groups of channel measurement resources as units.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. If the reference coefficient indication information is sent by taking a plurality of channel measurement resources as units, the reference coefficient indication information includes a plurality of channel measurement resource identification information or channel measurement resource combination identification information. A plurality of channel measurement resource identifications corresponding to each channel measurement resource combination identification are configured by the second base station 102, indicated by the terminal 101 or determined based on a default rule. Alternatively, if the reference coefficient indication information is sent by taking a plurality of port groups of channel resources as units, the reference coefficient indication information includes port group identification information of a plurality of channel measurement resources or combination identification information of port groups of channel measurement resources. A plurality of port group identifications of the channel measurement resources corresponding to combination identifications of port groups of each channel measurement resource are configured by the second base station 102, indicated by the terminal 101, or determined based on a default rule.

It may be noted that those skilled in the art can understand that the method according to the example of the present disclosure can be performed separately or together with some methods in the examples of the present disclosure or the related art.

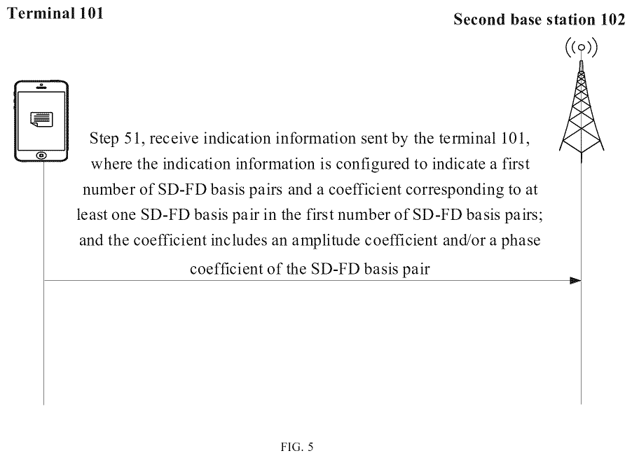

As shown in FIG. 4, a method for sending indication information of a spatial domain-frequency domain (SD-FD) basis pair is provided in the example. The method is performed by the terminal 101, and includes:
step 41, a coefficient of the second SD-FD basis pair different from the first SD-FD basis pair in SD-FD basis pairs is sent to the second base station 102.

The coefficient of the second SD-FD basis pair includes an amplitude coefficient and a phase coefficient of the second SD-FD basis pair. The amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs; and the amplitude coefficient of the second SD-FD basis pair is a differential value relative to the reference amplitude coefficient, and the phase coefficient of the second SD-FD basis pair is a differential value relative to a phase coefficient of the first SD-FD basis pair.

In an example, the reference coefficient indication information is sent to the second base station 102. The reference coefficient indication information is configured to indicate the first SD-FD basis pair; and the amplitude coefficient of the first SD-FD basis pair is the reference amplitude coefficient. The coefficient of a second SD-FD basis pair is sent to the second base station 102. The amplitude coefficient of the second SD-FD basis pair is a differential value relative to the reference amplitude coefficient; and the phase coefficient of the second SD-FD basis pair is a differential value relative to a phase coefficient of the first SD-FD basis pair.

It may be noted that those skilled in the art can understand that the method according to the example of the present disclosure can be performed separately or together with some methods in the examples of the present disclosure or the related art.

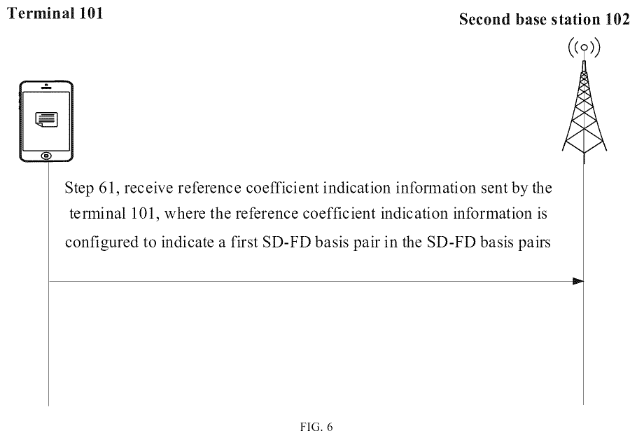

As shown in FIG. 5, a method for receiving indication information of a spatial domain-frequency domain (SD-FD) basis pair is provided in the example. The method is performed by the second base station 102, and includes:
step 51, indication information sent by a terminal 101 is received.

The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

The terminal 101 involved in the present disclosure may be, but not limited to, a mobile phone, a wearable device, a vehicle-mounted terminal, a road side unit (RSU), a smart home terminal, an industrial sensing device, and/or a medical device. In some examples, the terminal 101 may be a Redcap terminal or a predetermined version of new radio (NR) terminal (for example, an NR terminal of R17).

The second base station 102 is an interface device for the terminal 101 to access a network. The second base station 102 may be any type of base station, for example, a base station of a third generation mobile communication (3G) network, a base station of a fourth generation mobile communication (4G) network, a base station of a fifth generation mobile communication (5G) network, or other evolved base stations.

In an example, the indication information sent by the terminal 101 is received in response to establishment of a radio resource control (RRC) connection. The indication information is configured to indicate a first number of SD-FD basis pairs, and a coefficient corresponding to at least one SD-FD basis pair in the first number of SD-FD basis pairs, and the coefficient includes at least one of an amplitude coefficient or a phase coefficient of the at least one SD-FD basis pair.

In an example, a request information for acquiring the indication information is sent to the terminal 101; and the indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, information for determining the first number is sent to the terminal 101; and indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, the indication information sent by the terminal 101 is received. The indication information is configured to indicate a first number of SD-FD basis pairs and a coefficient corresponding to at least one SD-FD basis pair in the first number of SD-FD basis pairs, the coefficient includes at least one of an amplitude coefficient or a phase coefficient of the at least one SD-FD basis pair; and the first number is determined according to codebook parameter configuration information sent by the second base station 102 and/or number information of the SD-FD basis pairs sent by the second base station 102.

In an example, codebook parameter configuration information is sent to the terminal 101; and indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

Illustratively, for the codebook parameter configuration information, reference is made to L, p_{ν} and β in the table 1 anew, where M_{ν} (for example,

$${M}_{υ} = ⌈ {p}_{υ} \frac{{N}_{3}}{R} ⌉ ) .$$

N₃ and R may be obtained based on other configuration information. M_{ν} may be obtained based on p_{ν} in the codebook parameter configuration information. M_{ν} is M of a v-th layer. The first number determined based on the table 1 is β2LM (the number of basis pairs indicated at each layer). Illustratively, for the table 1, reference may be made to Rel-16 Type II-table 1. It may be noted that a value of each parameter may be different from that in the table 1, which is not limited in the present disclosure.

Illustratively, for the codebook parameter configuration information, reference is made to M, α and β in the table 2 anew. N₁ and N₂ may be obtained through other configuration information. The first number determined based on the table 2 is 2αBN₁N₂M (the number of basis pairs indicated at each layer). Illustratively, for table 2, reference may be made to a parameter table of Rel-17 Type II port selection codebook-table 2. It may be noted that a value of each parameter may be different from that in the table 2, which is not limited in the present disclosure.

It may be noted that determination of the first number is not limited to a parameter form of the above tables, and the second base station 102 provides a form of the value of each parameter just for the terminal 101 to determine the first number.

In an example, number information of SD-FD basis pairs is sent to the terminal 101; and indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

In an example, indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair. The amplitude coefficient is a non-zero coefficient.

It may be noted that if an amplitude coefficient of a selected SD-FD basis pair is zero, the terminal 101 indicates that the selected SD-FD basis pairs do not include the SD-FD basis pair.

In an example, indication information sent by the terminal 101 is received. The indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair. The amplitude coefficient of the SD-FD basis pair is non-zero.

In an example, indication information sent by the terminal 101 is received. The indication information is configured to indicate a first number of SD-FD basis pairs and a coefficient corresponding to at least one SD-FD basis pair in the first number of SD-FD basis pairs, the coefficient includes at least one of an amplitude coefficient or a phase coefficient of the at least one SD-FD basis pair; and a number of bits of an information domain of the indication information is determined based on the first number. Illustratively, if the first number is greater than a number threshold, the number of the bits of the information domain may be greater than a reference threshold; and alternatively, if the first number is less than the number threshold, the number of the bits of the information domain may be less than the reference threshold.

Illustratively, the number of enhanced bits based on the Rel-16 type II is:

$$⌈ {log}_{2} ( \begin{matrix}{N}_{1} {N}_{2} {N}_{3} \\ pair number\end{matrix} ) ⌉ .$$

N₁ and N₂ correspond to the number of first-dimension bases and the number of second-dimension bases respectively, and N₃ is the number of FD bases. When N₃ is greater than 19, N₃ may be replaced with a small value of a length of an FD window. A value of a length of the FD window is 2M in the similar related art. M is the number of FD bases to be selected. The pair number is the first number.

Illustratively, the number of enhanced bits based on the Rel-17 type II port selection codebook is:

$$⌈ {log}_{2} ( \begin{matrix}{N}_{1} {N}_{2} N \\ pair number\end{matrix} ) ⌉ .$$

N₁ and N₂ correspond to the number of first-dimension bases and the number of second-dimension bases respectively, and N is a length of the FD window. The pair number is the first number.

In an example, the SD-FD basis pairs include a first SD-FD basis pair and a second SD-FD basis pair.

In an example, reference coefficient indication information sent by the terminal 101 is received. The reference coefficient indication information is configured to indicate the first SD-FD basis pair in the SD-FD basis pairs; and an amplitude coefficient of the first SD-FD basis pair is a reference amplitude coefficient, and the reference amplitude coefficient is not less than an amplitude coefficient of a SD-FD basis pair other than the first SD-FD basis pair in the SD-FD basis pairs. For example, the reference amplitude coefficient is a maximum coefficient in the amplitude coefficients of the SD-FD basis pairs.

In an example, an SD-FD basis pair corresponding to a reference amplitude coefficient is indicated firstly, and a number of bits needed is:

┌log₂ pair number┐.

The pair number is the first number.

It may be noted that an amplitude of the SD-FD basis pair may be normalized to 1, and if a phase of the SD-FD basis pair is 0, report is not needed. For amplitudes and phases of other SD-FD basis pairs, a differential value relative to the SD-FD basis pair corresponding to relative reference amplitude coefficient may be reported.

In an example, reference coefficient indication information sent by the terminal 101 is received for different polarization directions. The reference coefficient indication information is configured to indicate the first SD-FD basis pair; and the amplitude coefficient of the first SD-FD basis pair is the reference amplitude coefficient.

In an example, reference coefficient indication information sent by the terminal 101 is received by taking one or more channel measurement resources as units. The reference coefficient indication information is configured to indicate the first SD-FD basis pair; and the amplitude coefficient of the first SD-FD basis pair is the reference amplitude coefficient.

In an example, reference coefficient indication information sent by the terminal 101 is received by taking one or more port groups of channel measurement resources as units. The reference coefficient indication information is configured to indicate the first SD-FD basis pair; and the amplitude coefficient of the first SD-FD basis pair is the reference amplitude coefficient.

In an example, reference coefficient indication information sent by the terminal 101 is received. The reference coefficient indication information is configured to indicate the first SD-FD basis pair; and the amplitude coefficient of the first SD-FD basis pair is the reference amplitude coefficient. The reference coefficient indication information includes channel measurement resource identification information; and alternatively, the reference coefficient indication information includes port group identification information of channel measurement resources.

In an example, reference coefficient indication information sent by the terminal 101 is received. The reference coefficient indication information is configured to indicate the first SD-FD basis pair; and the amplitude coefficient of the first SD-FD basis pair is the reference amplitude coefficient. The reference coefficient indication information includes channel measurement resource identification information in response to taking one or more channel measurement resources as units; and alternatively, the reference coefficient indication information includes port group identification information of channel measurement resources in response to taking one or more port groups of channel measurement resources as units.

In an example, reference coefficient indication information sent by the terminal 101 is received. The reference coefficient indication information is configured to indicate the first SD-FD basis pair; and the amplitude coefficient of the first SD-FD basis pair is the reference amplitude coefficient. If the terminal 101 sends the reference coefficient indication information by taking a plurality of channel measurement resources as units, the reference coefficient indication information includes a plurality of channel measurement resource identification information or channel measurement resource combination identification information. A plurality of channel measurement resource identifications corresponding to each channel measurement resource combination identification are configured by a second base station 102, indicated by a terminal 101 or determined based on a default rule. Alternatively, if the terminal 101 sends the reference coefficient indication information by taking a plurality of port groups of channel resources as units, the reference coefficient indication information includes port group identification information of channel measurement resources or combination identification information of port groups of channel measurement resource combinations. A plurality of port group identifications of the channel measurement resources corresponding to combination identifications of port groups of each channel measurement resource are configured by the second base station 102, indicated by the terminal 101, or determined based on a default rule.

In an example, reference coefficient indication information sent by the terminal 101 is received. The reference coefficient indication information is configured to indicate the first SD-FD basis pair; and the amplitude coefficient of the first SD-FD basis pair is the reference amplitude coefficient. A coefficient of the second SD-FD basis pair different from the first SD-FD basis pair in the SD-FD basis pairs is sent to the second base station 102. The coefficient of the second SD-FD basis pair includes an amplitude coefficient and a phase coefficient of the second SD-FD basis pair. The amplitude coefficient of the second SD-FD basis pair is a differential value relative to the reference amplitude coefficient; and the phase coefficient of the second SD-FD basis pair is a differential value relative to a phase coefficient of the first SD-FD basis pair.

In an example, for different transmitter receiver points (TRPs), a reference amplitude coefficient may be indicated for all the TRPs. That is, an SD-FD basis pair corresponding to the reference amplitude coefficient and a channel measurement resource identification (ID) or a port group ID of channel measurement resources corresponding to the reference amplitude coefficient need to be indicated, and non-reference SD-FD basis pairs of the TRPs and all SD-FD basis pairs of other TRPs are relative values for reference SD-FD basis pairs corresponding to the reference amplitude coefficient. Alternatively, each TRP indicates a respective reference amplitude coefficient, and SD-FD basis pairs corresponding to other non-reference amplitude coefficients in each TRP are differential values relative to reference SD-FD basis pairs corresponding to respective reference amplitude coefficients. That is, different TRPs correspond to different channel measurement resource identifications (IDs) or different port group IDs of the channel measurement resources. Indication of the channel measurement resource identifications (IDs) or the port group IDs of the channel measurement resources is equivalent to indication of the TRPs.

In an example, the channel measurement resources may be channel state information reference signal (CSI-RS) resources, port groups of the channel measurement resources may be one of a plurality of port groups into which ports corresponding to the CSI-RS are divided, and ports included in each port group are configured by the second base station 102 or determined based on a default rule.

It may be noted that those skilled in the art can understand that the method according to the example of the present disclosure can be performed separately or together with some methods in the examples of the present disclosure or the related art.

As shown in FIG. 6, a method for receiving indication information of a spatial domain-frequency domain (SD-FD) basis pair is provided in the example. The method is performed by the second base station 102, and includes:

Step 61, the reference coefficient indication information sent by the terminal 101 is received.

The reference coefficient indication information is configured to indicate the first SD-FD basis pair in the SD-FD basis pairs.

In an example, the reference coefficient indication information sent by the terminal 101 is received. The reference coefficient indication information is configured to indicate the first SD-FD basis pair in the SD-FD basis pairs; and the amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs.

In an example, the reference coefficient indication information sent by the terminal 101 is received for different polarization directions. The reference coefficient indication information is configured to indicate the first SD-FD basis pair in the SD-FD basis pairs; and the amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs.

In an example, the reference coefficient indication information sent by the terminal 101 is received by taking one or more channel measurement resources as units. The reference coefficient indication information is configured to indicate the first SD-FD basis pair; and the amplitude coefficient of the first SD-FD basis pair is the reference amplitude coefficient.

In an example, the reference coefficient indication information sent by the terminal 101 is received by taking one or more port groups of channel measurement resources as units. The reference coefficient indication information is configured to indicate the first SD-FD basis pair; and the amplitude coefficient of the first SD-FD basis pair is the reference amplitude coefficient.

In an example, the reference coefficient indication information sent by the terminal 101 is received. The reference coefficient indication information is configured to indicate the first SD-FD basis pair; and the amplitude coefficient of the first SD-FD basis pair is the reference amplitude coefficient. The reference coefficient indication information includes channel measurement resource identification information; and alternatively, the reference coefficient indication information includes port group identification information of channel measurement resources.

In an example, the reference coefficient indication information sent by the terminal 101 is received. The reference coefficient indication information is configured to indicate the first SD-FD basis pair; and the amplitude coefficient of the first SD-FD basis pair is the reference amplitude coefficient. The reference coefficient indication information includes channel measurement resource identification information in response to taking one or more channel measurement resources as units; and alternatively, the reference coefficient indication information includes port group identification information of channel measurement resources in response to taking one or more port groups of channel measurement resources as units.

In an example, the reference coefficient indication information sent by the terminal 101 is received. The reference coefficient indication information is configured to indicate the first SD-FD basis pair; and the amplitude coefficient of the first SD-FD basis pair is the reference amplitude coefficient. If the terminal 101 sends the reference coefficient indication information by taking a plurality of channel measurement resources as units, the reference coefficient indication information includes a plurality of channel measurement resource identification information or channel measurement resource combination identification information. A plurality of channel measurement resource identifications corresponding to each channel measurement resource combination identification are configured by the second base station 102, indicated by the terminal 101 or determined based on a default rule. Alternatively, if the terminal 101 sends the reference coefficient indication information by taking a plurality of port groups of channel resources as units, the reference coefficient indication information includes port group identification information of a plurality of channel measurement resources or combination identification information of port groups of channel measurement resources. A plurality of port group identifications of the channel measurement resources corresponding to combination identifications of port groups of each channel measurement resource are configured by the second base station 102, indicated by the terminal 101, or determined based on a default rule.

It may be noted that those skilled in the art can understand that the method according to the example of the present disclosure can be performed separately or together with some methods in the examples of the present disclosure or the related art.

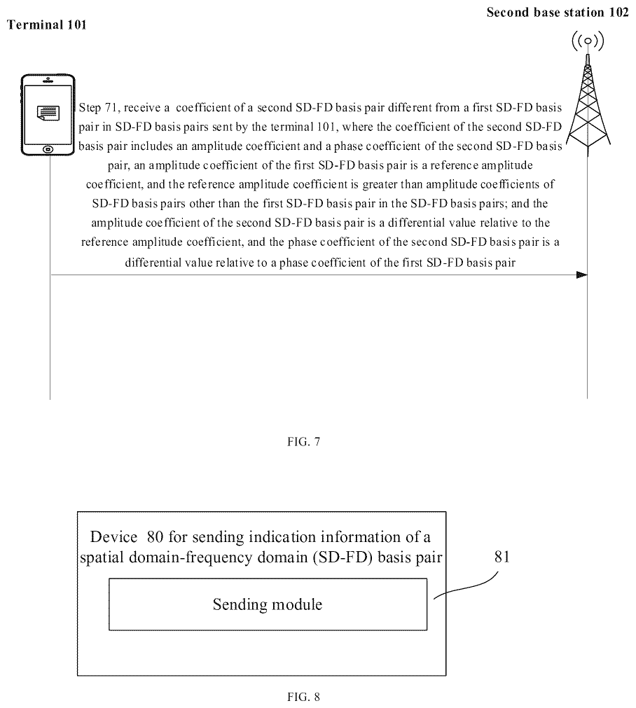

As shown in FIG. 7, a method for receiving indication information of a spatial domain-frequency domain (SD-FD) basis pair is provided in the example. The method is performed by the second base station 102, and includes:

step 71, a coefficient of the second SD-FD basis pair different from the first SD-FD basis pair in SD-FD basis pairs sent by the terminal 101 is received.

The coefficient of the second SD-FD basis pair includes an amplitude coefficient and a phase coefficient of the second SD-FD basis pair. The amplitude coefficient of the first SD-FD basis pair is the reference amplitude coefficient, and the reference amplitude coefficient is not less than an amplitude coefficient of a SD-FD basis pair other than the first SD-FD basis pair in the SD-FD basis pairs; and the amplitude coefficient of the second SD-FD basis pair is a differential value relative to the reference amplitude coefficient, and the phase coefficient of the second SD-FD basis pair is a differential value relative to a phase coefficient of the first SD-FD basis pair.

In an example, the reference coefficient indication information sent by the terminal 101 is received. The reference coefficient indication information is configured to indicate the first SD-FD basis pair; and the amplitude coefficient of the first SD-FD basis pair is the reference amplitude coefficient. A coefficient of the second SD-FD basis pair is sent to the second base station 102. The coefficient of the second SD-FD basis pair includes an amplitude coefficient and a phase coefficient of the second SD-FD basis pair. The amplitude coefficient of the second SD-FD basis pair is a differential value relative to the reference amplitude coefficient; and the phase coefficient of the second SD-FD basis pair is a differential value relative to a phase coefficient of the first SD-FD basis pair.

It may be noted that those skilled in the art can understand that the method according to the example of the present disclosure can be performed separately or together with some methods in the examples of the present disclosure or the related art.

As shown in FIG. 8, a device 80 for sending indication information of a spatial domain-frequency domain (SD-FD) basis pair is provided in the example. The device 80 includes:
a sending module 81, configured to send indication information to a second base station 102, where
the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

It may be noted that those skilled in the art can understand that the method according to the example of the present disclosure can be performed separately or together with some methods in the examples of the present disclosure or the related art.

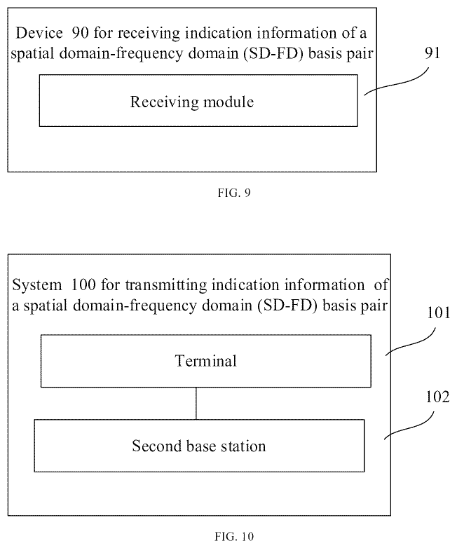

As shown in FIG. 9, a device 90 for receiving indication information of a spatial domain-frequency domain (SD-FD) basis pair is provided in the example. The device 90 includes:
a receiving module 91 configured to receive indication information sent by a terminal 101, where
the indication information is configured to indicate a first number of SD-FD basis pairs and a coefficient corresponding to at least one SD-FD basis pair in the first number of SD-FD basis pairs, and the coefficient includes at least one of an amplitude coefficient or a phase coefficient of the at least one SD-FD basis pair.

It may be noted that those skilled in the art can understand that the method according to the example of the present disclosure can be performed separately or together with some methods in the examples of the present disclosure or the related art.

For the device in the above example, a specific mode for each module to perform an operation has been described in detail in the example relating to the method, which will not be repeated here.

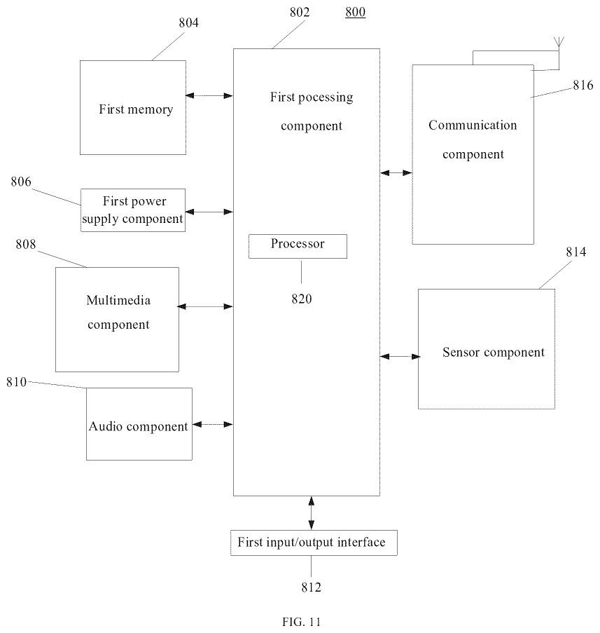

As shown in FIG. 10, a system 100 for transmitting indication information of a spatial domain-frequency domain (SD-FD) basis pair is provided in the example. The system 100 includes a terminal 101 and a second base station 102. The terminal 101 performs the method according to any example of the present disclosure, and the second base station 102 performs the method according to any example of the present disclosure.

It may be noted that those skilled in the art can understand that the method according to the example of the present disclosure can be performed separately or together with some methods in the examples of the present disclosure or the related art.

A communication device is provided in an example of the present disclosure. The communication device includes:
a memory that stores computer-executable instructions; and
one or more processors that are communicatively coupled to the memory, where the computer-executable instructions when collectively executed by the one or more processors cause the communication device to implement the method applied to any example of the present disclosure when running the executable instructions.

The processor may include any type of storage medium. The storage medium is a non-transitory computer storage medium that may continue to memorize information stored on the communication device after power failure.

The processor may be connected to the memory through a bus, and is configured to read an executable program stored in the memory.

A non-transitory computer storage medium is further provided in an example of the present disclosure. The non-transitory computer storage medium stores computer-executable instructions, and the executable instructions implement the method of any example of the present disclosure when executed by a processor.

For the device in the above example, a specific mode for each module to perform an operation has been described in detail in the example relating to the method, which will not be repeated here.

FIG. 11 is a block diagram of a second user equipment (UE) 800 shown according to an example. For example, the second UE 800 may be a mobile phone, a computer, digital broadcast user equipment, a message sending and receiving device, a game console, a tablet device, a medical device, a fitness device, a personal digital assistant, etc.

With reference to FIG. 11, the second UE 800 may include one or more of the following components: a first processing component 802, a first memory 804, a first power supply component 806, a multimedia component 808, an audio component 810, a first input/output (I/O) interface 812, a sensor component 814 and a communication component 816.

Overall operations of the second UE 800, such as operations associated with display, phone calls, data communications, camera operations and recording operations, are generally controlled by the first processing component 802. The first processing component 802 may include one or more processors 820 to execute an instruction to complete all or some of steps of the method described above. Further, the first processing component 802 may include one or more modules that facilitate interaction between the first processing component 802 and other components. For example, the first processing component 802 may include a multimedia module, so as to facilitate interaction between the multimedia component 808 and the first processing component 802.

The first memory 804 is configured to store any type of data to support operations at the second UE 800. Examples of such data include instructions, contact data, phone book data, messages, pictures, videos, etc., for any application or method operated on the second UE 800. The first memory 804 may be implemented by any type of volatile or non-volatile storage device, or a combination of any type of volatile or non-volatile storage device, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power is provided by the first power supply component 806 for various components of the second UE 800. The first power supply component 806 may include a power management system, one or more power supplies, and other components associated with generation, management and distribution of power for the second UE 800.

The multimedia component 808 includes a screen that provides an output interface between the second UE 800 and a user. In some examples, the screen may include a liquid crystal display (LCD) and a touch panel (TP). If the screen includes the TP, the screen may be implemented as a touch screen to receive an input signal from the user. The TP includes one or more touch sensors to sense touching, swiping, and gestures on the TP. A boundary of a touch or swiping action may be sensed by the touch sensor, and duration and pressure associated with a touching or swiping operation may be further detected by the touch sensor. In some examples, the multimedia component 808 includes a front-facing camera and/or a rear-facing camera. When the second UE 800 is in an operation mode, such as a photographing mode or a video mode, external multimedia data may be received by the front-facing camera and/or the rear-facing camera. Each front-facing camera and each rear-facing camera may be a fixed optical lens system or have a focal length and an optical zoom capability.

The audio component 810 is configured to output and/or input an audio signal. For example, the audio component 810 includes a microphone (MIC). The MIC is configured to receive an external audio signal when the second UE 800 is in an operating mode, such as a call mode, a recording mode, and a voice recognition mode. The received audio signal may be further stored in the first memory 804 or sent via the communication component 816. In some examples, the audio component 810 further includes a loudspeaker for outputting the audio signal.

An interface is provided by the first I/O interface 812 between the first processing component 802 and a peripheral interface module. The peripheral interface module described above may be a keyboard, a click wheel, a button, etc. The button may include, but not limited to, a home button, a volume button, a start button, and a lock button.

The sensor component 814 includes one or more sensors configured to provide state assessments of various aspects for the second UE 800. For example, an open/closed state of the second UE 800, and a relative positioning of components may be detected by the sensor component 814. For example, the component is a display and a keypad of the second UE 800. A change in position of the second UE 800 or a component of the second UE 800, presence or absence of the user making contact with the second UE 800, orientation or acceleration/deceleration of the second UE 800, and a change in temperature of the second UE 800 may be further detected by the sensor component 814. The sensor component 814 may include a proximity sensor configured to detect presence of nearby objects in the absence of any physical contact. The sensor component 814 may further include a light sensor, such as a CMOS image sensor or a CCD image sensor, used in imaging applications. In some examples, the sensor component 814 may further include an acceleration sensor, a gyro sensor, a magnetic sensor, a pressure sensor, or a temperature sensor.

The communication component 816 is configured to facilitate communication between the second UE 800 and other devices in a wired or wireless manner. A wireless network based on a communication standard, such as WiFi, 2G, 3G, or a combination of the WiFi, the 2G and the 3G, may be accessed by the second UE 800. In an example, a broadcast signal or broadcast related information from an external broadcast management system is received by the communication component 816 via a broadcast channel. In an example, the communication component 816 further includes a near field communication (NFC) module to facilitate short range communication. For example, the NFC module may be implemented based on a radio frequency identification (RFID) technology, an infrared data association (IrDA) technology, a ultra wide band (UWB) technology, a Bluetooth (BT) technology, and other technologies.

In an example, the second UE 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is configured to perform the method described above.

In an example, a non-transitory computer-readable storage medium including an instruction is further provided, such as the memory 804 including an instruction. The instruction is executable by the processor 820 of the second UE 800, so as to complete the method described above. For example, the non-transitory computer-readable storage medium may be a ROM, a random access memory (RAM), a CD-ROM, a magnetic tape, a floppy disk, an optical data storage device, etc.

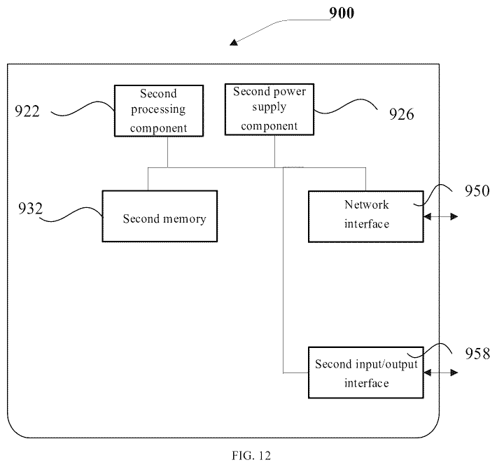

As shown in FIG. 12, a structure of a third base station is shown in an example of the present disclosure. For example, the third base station 900 may be provided as a network-side device. With reference to FIG. 12, the third base station 900 includes a second processing component 922. The processing component further includes one or more processors, and memory resources represented by a second memory 932, which are configured to store an instruction, for example, an application, executable by the second processing component 922. The application stored in the second memory 932 may include one or more modules, each corresponding to a group of instructions. Further, the second processing component 922 is configured to execute the instruction, so as to perform any of the above methods previously applied to the second base station, for example, the methods shown in FIGS. 5-7.

The third base station 900 may further include a second power supply component 926 configured to perform power management for the third base station 900, a wired or wireless network interface 950 configured to connect the third base station 900 to a network, and a second input/output (I/O) interface 958. The third base station 900 may operate an operating system stored in the second memory 932, such as Windows Server™, Mac OS X™, Unix™, Linux™, FreeBSD™, or the like.

It can be understood that the first base station, second base station and third base station are provided for illustrative purpose. The first base station, second base station and third base station may be the same base station or different base stations, which is not limited in the present disclosure. The first UE and second UE are also provided for illustrative purpose, where the first UE and second UE may be the same UE or different UEs, which is not limited in the present disclosure.

Those skilled in the art could easily conceive of other implementation solutions of the present disclosure upon consideration of the description and the present disclosure disclosed in the implementation. The present disclosure is intended to cover any variations, uses or adaptive changes of the present disclosure, which follow the general principles of the present disclosure and include common general knowledge or customary technical means, which is not disclosed in the present disclosure, in the technical field. The description and the examples are to be regarded as illustrative, and the true scope and spirit of the present disclosure are indicated by the appended claims.

It may be understood that the present disclosure is not limited to a precise structure which has been described above and illustrated in the accompanying drawings, and can have various modifications and changes without departing from the scope of the present disclosure. The scope of the present disclosure is limited by the appended claims.

1. A method for sending indication information of a spatial domain-frequency domain (SD-FD) basis pair, performed by a terminal, the method comprising:
sending indication information to a base station, wherein the indication information is configured to indicate a first number of SD-FD basis pairs and a coefficient corresponding to at least one SD-FD basis pair in the first number of SD-FD basis pairs, and the coefficient comprises at least one of an amplitude coefficient or a phase coefficient of the at least one SD-FD basis pair.

2. The method according to claim 1, further comprising at least one of the following:
receiving codebook parameter configuration information sent by the base station, and determining the first number according to the codebook parameter configuration information;
receiving number information of the SD-FD basis pairs sent by the base station, and determining the first number according to the number information of the SD-FD basis pairs; or
receiving the codebook parameter configuration information and the number information of the SD-FD basis pairs sent by the base station, and determining the first number according to the codebook parameter configuration information and the number information of the SD-FD basis pairs.

3. The method according to claim 1, wherein a number of bits of an information domain of the indication information is determined based on the first number.

4. The method according to claim 1, wherein the SD-FD basis pairs comprise a first SD-FD basis pair and a second SD-FD basis pair, and the indication information is reference coefficient indication information, wherein the reference coefficient indication information is configured to indicate the first SD-FD basis pair.

5. The method according to claim 4, wherein an amplitude coefficient of the first SD-FD basis pair is a reference amplitude coefficient, and the reference amplitude coefficient is no less than an amplitude coefficient of a SD-FD basis pair other than the first SD-FD basis pair in the SD-FD basis pairs.

6. The method according to claim 4, further comprising:
sending a coefficient of the second SD-FD basis pair to the base station, wherein the coefficient of the second SD-FD basis pair comprises an amplitude coefficient and a phase coefficient of the second SD-FD basis pair, and the amplitude coefficient of the second SD-FD basis pair is a differential value relative to a reference amplitude coefficient, and the phase coefficient of the second SD-FD basis pair is a differential value relative to a phase coefficient of the first SD-FD basis pair, wherein an amplitude coefficient of the first SD-FD basis pair is the reference amplitude coefficient.

7. The method according to claim 4, further comprising:
sending the reference coefficient indication information to the base station for different polarization directions.

8. The method according to claim 4, wherein the reference coefficient indication information comprises channel measurement resource identification information or port group identification information of channel measurement resources.

9. A method for receiving indication information of a spatial domain-frequency domain (SD-FD) basis pair, performed by a base station, the method comprising:
receiving indication information sent by a terminal, wherein the indication information is configured to indicate a first number of SD-FD basis pairs and a coefficient corresponding to at least one SD-FD basis pair in the first number of SD-FD basis pairs, and the coefficient comprises at least one of an amplitude coefficient or a phase coefficient of the at least one SD-FD basis pair.

10. The method according to claim 9, further comprising at least one of the following:
sending codebook parameter configuration information to the terminal;
sending number information of the SD-FD basis pairs to the terminal; or
sending the codebook parameter configuration information and the number information of the SD-FD basis pairs to the terminal.

11. The method according to claim 9, wherein a number of bits of an information domain of the indication information is determined based on the first number.

12. The method according to claim 9, wherein the SD-FD basis pairs comprise a first SD-FD basis pair and a second SD-FD basis pair, and the indication information is reference coefficient indication information, wherein the reference coefficient indication information is configured to indicate the first SD-FD basis pair.

13. The method according to claim 12, wherein an amplitude coefficient of the first SD-FD basis pair is a reference amplitude coefficient, and the reference amplitude coefficient is no less than an amplitude coefficient of a SD-FD basis pair other than the first SD-FD basis pair in the SD-FD basis pairs.

14. The method according to claim 13, further comprising:
receiving a coefficient of the second SD-FD basis pair sent by the terminal, wherein
the coefficient of the second SD-FD basis pair comprises an amplitude coefficient and a phase coefficient of the second SD-FD basis pair, and the amplitude coefficient of the second SD-FD basis pair is a differential value relative to the reference amplitude coefficient, and the phase coefficient of the second SD-FD basis pair is a differential value relative to a phase coefficient of the first SD-FD basis pair.

15. The method according to claim 12, further comprising:
receiving the reference coefficient indication information sent by the terminal for different polarization directions.

16. The method according to claim 12, wherein
the reference coefficient indication information comprises channel measurement resource identification information or port group identification information of channel measurement resources.

17-18. (canceled)

19. A system for transmitting indication information of a spatial domain-frequency domain (SD-FD) basis pair, the system comprising:
a terminal; and
a base station, wherein
the terminal performs the method according to claim 1.

20. A communication device, comprising:
a memory that stores computer-executable instructions; and
one or more processors that are communicatively coupled to the memory, wherein the computer-executable instructions when collectively executed by the one or more processors cause the communication device to:
send indication information to a base station, wherein the indication information is configured to indicate a first number of SD-FD basis pairs and a coefficient corresponding to at least one SD-FD basis pair in the first number of SD-FD basis pairs, and the coefficient comprises at least one of an amplitude coefficient or a phase coefficient of the at least one SD-FD basis pair.

21. A non-transitory computer storage medium storing computer-executable instructions, wherein the computer-executable instructions, when collectively executed by one or more processors, cause the one or more processors to implement the method according to claim 1.

22. A communication device, comprising:
a memory that stores computer-executable instructions; and
one or more processors that are communicatively coupled to the memory, wherein the computer-executable instructions, when collectively executed by the one or more processors, cause the communication device to implement the method according to claim 9.
